(19) United States
(12) Patent Application Publication
(10) Pub. No.: US 2002/0116599 A1
(43) Pub. Date: Aug. 22, 2002

(54) DATA PROCESSING APPARATUS

(76) Inventors: MASAHIRO KAINAGA, TOKYO (JP); YASUHIKO SAITOO, SAGAMIHARA-SHI (JP)

Correspondence Address: FAY SHARPE BEALL FAGAN, MINNICH & MCKEE, 104 EAST HUME AVENUE, ALEXANDRIA, VA, 22301

(21) Appl. No.: 08/816,500

(22) Filed: Mar. 13, 1997

(30) Foreign Application Priority Data
Mar. 18, 1996 (JP) 8-060571

(51) Int. Cl. G06F 9/30

(52) U.S. Cl. 712/209; 712/218

(57) ABSTRACT

To eliminate pipeline stall due to data hazard in a superscalar system and to increase the processing speed. An instruction decoder is provided with a circuit which detects two neighboring 2-operand instructions which are equivalent to one 3-operand instruction, and a circuit which, if it is equivalent, integrates the two instructions into the 3-operand instruction and sends it to a succeeding execution stage. Or, provision is made of a circuit which sends the source data of a preceding instruction to an arithmetic unit for a succeeding instruction when the two neighboring instructions have a relationship of data flow but cannot be integrated into one 3-operand instruction. It is allowed to execute the processing of two instructions in one clock, which so far required two clocks due to data flow between the neighboring instructions. Therefore, the number of execution clocks as a whole can be decreased.

### BACKGROUND OF THE INVENTION

The present invention relates to a data processing apparatus such as a microprocessor or a microcomputer. More specifically, the invention relates to technology that can be effectively adapted to a data processing apparatus for executing parallel processing such as of superscalar, etc.

A microprocessor (which is a general term for a CPU (central processing unit), a microcomputer, etc.) sequentially fetches a string of instructions, decodes them, and executes them. Instructions executed by the microprocessor nowadays are mostly those of fixed lengths in order to simplify the decoding circuit. A microprocessor which executes instructions of a fixed length by pipelining is called processor of an RISC (reduced instruction set computer) type.

FIG. 1 illustrates a method of realizing a pipelined microprocessor. For the purpose of simplicity, here, a stage of memory access (MEM) which usually exists is omitted. The individual stages (101, 103, 105, 107) are executed in a unit of time clock (clock), and the processings of the individual instructions are finished upon sequentially accumulating the processings from a first stage to a final stage via latch groups (102, 104, 106). The first stage 101 fetches instructions (IF). The second stage 103 interprets the instructions and reads a register (ID). The third stage 105 executes an operation designated by an instruction function (EX). The fourth stage 107 writes the operated result into a register arranged in the second stage 103 via a signal line 108 (WB).

FIG. 2 is a diagram schematically illustrating a processing of four instructions by pipelining. When a succeeding instruction uses the content of a register of a preceding instruction, the pipeline of the succeeding instruction becomes empty (called pipeline stall caused by data hazard). This state is shown in FIG. 2(a). In FIG. 2(a), two arrows directed to the lower left indicate that a preceding instruction is written into the register and then a succeeding instruction is read out from the register.

When the succeeding instruction uses the result of the preceding operation as means for solving the problem, therefore, the value is also sent to an arithmetic unit in the third stage 105 via a signal line 108. The control lines for the above operation are signal lines 109 and 110. This control operation has been known as forwarding and clock-by-clock execution is possible. In FIG. 2(b), the two arrows directed to the lower left indicate forwarding. Therefore, the number of clocks required for processing the individual instructions is, for example, four. However, since the individual stages process new instructions in every clock, the processing executes one instruction per clock. Since each instruction is executed in one clock, the execution time becomes shorter with a decrease in the number of execution instructions for executing a processing (program).

The pipelining and forwarding have been disclosed in Hennessy (at al. “Computer Organization and Design”, Chapter 6, Enhancing Performance with Pipelining, pp. 362-450, 1994, Morgan Kaufman Publishers, Inc.

Next, a system for increasing the processing speed of the microprocessor can be represented by a superscalar system. The superscalar system employs a plurality of arithmetic units, e.g., two arithmetic units that can be executed simultaneously, and enables two instruction fetches and two instruction decodings to be executed at one time. In this case, as shown in FIG. 3(a) of when there is no dependency on the data, two instructions can be ideally executed in every clock, and the execution time is halved compared with the ordinary pipelining system. The superscalar system has been disclosed in Nikkei Electronics, No. 487, Nov. 27, 1989, pp. 191-200 “RISC of Next Generation, Aiming at 100 MIPS with CMOS by introducing Parallel Processing”.

In general, in the microprocessor of the RISC type employing the conventional superscalar system, the instructions have a fixed length of 4 bytes, and the number of operands of an operation instruction such as arithmetic operation is three. This has been disclosed in application No. 1989/433368. In order to enhance the coding efficiency (to decrease the amount of use of the memory for storing instructions), there has been proposed a microprocessor of the RISC type using the instructions of a fixed length of 2 bytes. However, the superscalar system is not employed for the microprocessor of the RISC type which uses the instructions having the fixed length of 2 bytes. This has been disclosed in application No. 1992/897457.

### SUMMARY OF THE INVENTION

Issues involved with the superscalar system will now be described with reference to FIG. 3. Described below are the operations of the instructions shown in FIG. 3.

(1) mov R3, R2 “Copy the content of register R3 into register R2”.

(2) mov #32, R5 “Copy data *32* into register R5”.

(3) adc R4, R2 “Add up the content of register R4 and the content of R2 together, and store the result in R2”.

(4) and R3, R5 “AND the content of register R3 with the content of R5, and store the result in R5”.

There is no data dependency (data flow) between the instruction (1) and the instruction (2) or between the instruction (3) and the instruction (4). There, however, exists a data dependency (data flow) between the instruction (1) and the instruction (3) and between the instruction (2) and the instruction (4). That is, the register R2 is used by both the instruction (1) and the instruction (3). The register R5 is used by both the instruction (2) and the instruction (4). Therefore, the instruction (3) must be executed after the instruction (1) is executed. Moreover, the instruction (4) must be executed after the instruction (2) is executed.

That is, when there is no data dependency between the instructions that are simultaneously executed, there is no vacancy in the pipeline as shown in FIG. 3(a); i.e., two instructions are executed in completely parallel with each other, and the processing speed is doubled compared with when only one instruction is executed at one time in the prior art. When there is a data dependency between the instructions that are simultaneously executed, however, the pipelining is disturbed as shown in FIG. 3(b), and the processing speed becomes the same as that when only one instruction is executed at one time in the prior art.

When there is a data dependency between the instructions that are simultaneously executed, therefore, a method may be used to avoid disturbance in the pipelines by executing the succeeding instruction in the next pipeline and by executing a non-processing instruction nop simultaneously with the preceding instruction instead of the succeeding instruction as shown in FIG. 3(c). This, however, results in an increase in the wasteful instruction, an increase in the number of the whole instructions to be executed, and an increase in the execution time.

Described below with reference to FIGS. 4 and 5 is an issues involved with the instruction format and in the instruction architecture.

FIG. 4 illustrates an instruction format and an instruction repertoire of the case of a 4-byte/3-operand instruction (instruction of a fixed length of 4 bytes) architecture. In FIG. 4, an OP-field 401 specifies an instruction function. In an S1-field 403 is placed a register number (first operand) for specifying a first input, in an S2-field 404 is placed a register number (second operand) for specifying a second input, and in a D-field 402 is placed a register number (third operand) for specifying an output. In effect, this instruction format is capable of designating three operands. The instruction function includes copy (transfer of data), addition and subtraction. Furthermore, the 4-byte instruction architecture has a margin in the instruction length to offer composite instructions such as 1-bit left shift addition instruction aslladd, 0-extended addition instruction zextadd, etc. The aslladd instruction effects an ordinary addition after a bit pattern of the first operand is leftwardly shifted by 1 bit, and the zextadd instruction effects an ordinary addition after the left half of the bit pattern of the first operand is set to 0. For the purpose of simplicity, here, a memory access instruction and a branch instruction, that will usually exist, are omitted. In the case of a copy instruction (data transfer instruction), the S2-field 404 is neglected, and the content of a register (which is the source of transfer) specified by the S1-field 403 is directly copied (transferred) into a register (which is the destination of transfer) specified by the D-field 402.

FIG. 5 illustrates an instruction format and an instruction repertoire of the case of a 2-byte/2-operand instruction (instruction having a fixed length of 2 bytes) architecture. In FIG. 5, an OP-field 501 specifies an instruction function. In an S1-field 503 is placed a register number (first operand) for specifying a first input, and in a D-field 502 is placed a register number (same as the register number for specifying an output, second operand) for specifying a second input. In effect, this instruction format is capable of designating two operands. When compared with FIG. 4, there exists no S2-field, which is a distinct difference from the instruction format of FIG. 4. That is, the number of the operands is less by one. The remaining field lengths are shorter than those of FIG. 4.

The instruction function includes a copy instruction (data transfer instruction) as an input transfer instruction, a 0-extended instruction, a code extended instruction, a 1-bit left shift instruction, an addition instruction as a 2-input operation instruction and a subtraction instruction. Among them, the 1-bit left shift instruction has an input register (which is at a source of transfer) number which is the same as an output register (which is at a destination of transfer) number due to the length of instruction. In this case, therefore, the S1-field stores an extended instruction code for specifying an asll instruction instead of storing a register number.

In order to clarify merits and demerits of the 4-byte/3-operand instruction architecture and the 2-byte/2-operand instruction architecture, the following formula will now be considered,

a=b+c+d (A)

This can be converted into a string of instructions (string of instructions (A1)) of the 4-byte/3-operand instruction architecture as follows:

add Rb, Rc, Ra
add Ra, Rd, Ra

This, on the other hand, can be converted into a string of instructions (string of instructions (A2)) of the 2-byte/2-operand instruction architecture as follows:

mov Rb, Ra
add Rc, Ra
add Rd, Ra

In the 4-byte/3-operand instruction architecture, the number of execution instructions is 2 and the number of storage bytes (and an instruction fetch for execution) in the instruction memory is 8. In the 2-byte/2-operand instruction architecture, on the other hand, the number of the execution instructions increases to 3 but the number of storage bytes (and an instruction -fetch for execution) in the instruction memory decreases to 6. This tendency generally holds true. It can be generally recognized that the 4-byte/3-operand instruction architecture requires 10 to 20% less execution instructions in number than the 2-byte/2-operand instruction architecture but requires about 60%. more storage bytes in number.

The 2-byte/2-operand instruction architecture, however, has a problem concerning an extra data transfer instruction that is necessary in the case of the 2-operan(d instruction architecture. This will be explained by using the following formula (B) though this can similarly be explained by using the above formula (A),

a=b+c (B)

This can be converted into a string of instructions (string of instructions (B1)) of the 4-byte/3-operand instruction architecture as follows:

add Rb, Rc, Ra

This, on the other hand, can be converted into a string of instructions (string of instructions (B2)) of the 2-byte/2-operand instruction architecture as follows:

mov Rb, Ra
add Rc, Ra

The 4-byte/3-operand instruction architecture can be executed in 1 clock by using only one side of the pipelines. In the 2-byte/2-operand instruction architecture, on the other hand, there exists a data flow between the two instructions, i.e., between a copy (data transfer) instruction mov that is additionally required and the succeeding addition instruction add. That is, the value of result of the preceding instruction is used by the succeeding instruction. Therefore, the succeeding instruction add must be executed after obtaining the result of the preceding instruction mov, requiring an execution time of 2 clocks. In the following string of instructions,

mov Rb, Ra
add Rc, Rd

there is no data flow between the two instructions, and the instructions can be executed in 1 clock by using two pipelines. In the string of instructions (B2) corresponding to the formula (B), an extra processing time is required due to the presence of the data flow. When a superscalar system is employed, it can be said that the 2-byte/2-operand instruction architecture tends to require more execution time for its number of the execution instructions than the 4-byte/3-operand instruction architecture.

In the foregoing was described the problem of the 2-byte/2-operand instruction architecture in comparison with the 4-byte/3-operand instruction architecture. Even in the 4-byte/3-operand instruction architecture, however, there exists the data flow like in the above-mentioned string of instructions (A1) when the operation of 4 operands is executed, and there remains the problem same as that of the 2-byte/2-operand instruction architecture.

The microprocessor existing so far is based on an accumulation of software assets and succeeds the software assets built up so far, and is not allowed to change its instruction format or instruction architecture. It is therefore necessary to increase the processing speed while maintaining the traditional instruction format and instruction architecture.

The issue of the present invention is to increase the processing speed by decreasing the pipeline stall caused by data hazard in the superscalar system.

Another issue of the present invention is to increase the processing speed by decreasing the number of the execution instructions.

A further issue of the present invention is to increase the processing speed of the data processing apparatus which executes the 2-byte/2-operand instruction architecture.

The above and other assignments as well as novel features of the present invention will become obvious from the description of the specification and the accompanying drawings.

Briefly described below is a representative example of the invention disclosed in this application.

The data processing apparatus of the pipeline system has a stage for reading instructions of a fixed length stored in an instruction memory, a stage which, when there is dependency among the data executed by a plurality of instructions that are read and when there is a predetermined relationship among said plurality of instructions, changes said plurality of instructions so that said plurality of instructions can be executed in parallel by a plurality of pipelines, and a stage for executing said plurality of changed instructions in parallel.

The instruction architecture is the 2-byte/2-operand instruction architecture which, however, is treated internally as a 3-operand instruction architecture. That is, the instruction fetch stage fetches two instructions. The instruction decoder stage decodes the two neighboring instructions. The operation stage is equipped with two arithmetic units. An instruction decoder is provided with means which detects that two neighboring 2-operand instructions are equal to a 3-operand instruction, and means which, when the above operand instructions are detected, integrates the two instructions into one 3-operand instruction and send the result to a succeeding execution stage. Thus, the two instructions are sent as one 3-operand instruction to the execution stage and are executed in 1 clock. When it is detected that the two neighboring instructions have a relation of data flow but cannot be integrated into a 3-operand instruction, provision is made of means which sends the source data of the preceding instruction to the arithmetic unit for a succeeding instruction.

Thus, it is made possible to simultaneously execute the two instructions. Owing to the above-mentioned features, the two instruction processings can now be executed in 1 clock though they had to be executed so far requiring 2 clocks due to the data flow between the neighboring instructions. Therefore, the number of the execution clocks as a whole can be decreased.

### BRIEF DESCRIPTION OF THE DRAWINGS

FIG. 1 illustrates a system for realizing a microprocessor by pipelining;

FIG. 2 schematically illustrates a pipeline processing;

FIG. 3 schematically illustrates a superscalar processing;

FIG. 4 illustrates an instruction format and an instruction repertoire in a 4-byte instruction architecture;

FIG. 5 illustrates an instruction format and an instruction repertoire in a 2-byte instruction architecture;

FIG. 6 illustrates data paths of pipelines in a microprocessor according to an embodiment of the present invention;

FIG. 7 is a block diagram illustrating a first stage and a first latch group in detail;

FIG. 8 is a block diagram illustrating a second stage and a second latch group in detail;

FIG. 9 is a block diagram illustrating a third stage and a third latch group in detail;

FIG. 10 is a block diagram illustrating the operation of a fourth stage;

FIG. 11 illustrates rules for converting two instructions in an instruction decoder stage into two instructions in an operation stage;

FIG. 12 is a block diagram illustrating part of a decode control unit in detail;

FIG. 13 illustrates how a string of instructions are processed in the individual clocks;

FIG. 14 is a diagram illustrating a microcomputer system using a superscalar system of the present invention; and

FIG. 15 is a block diagram of a register file.

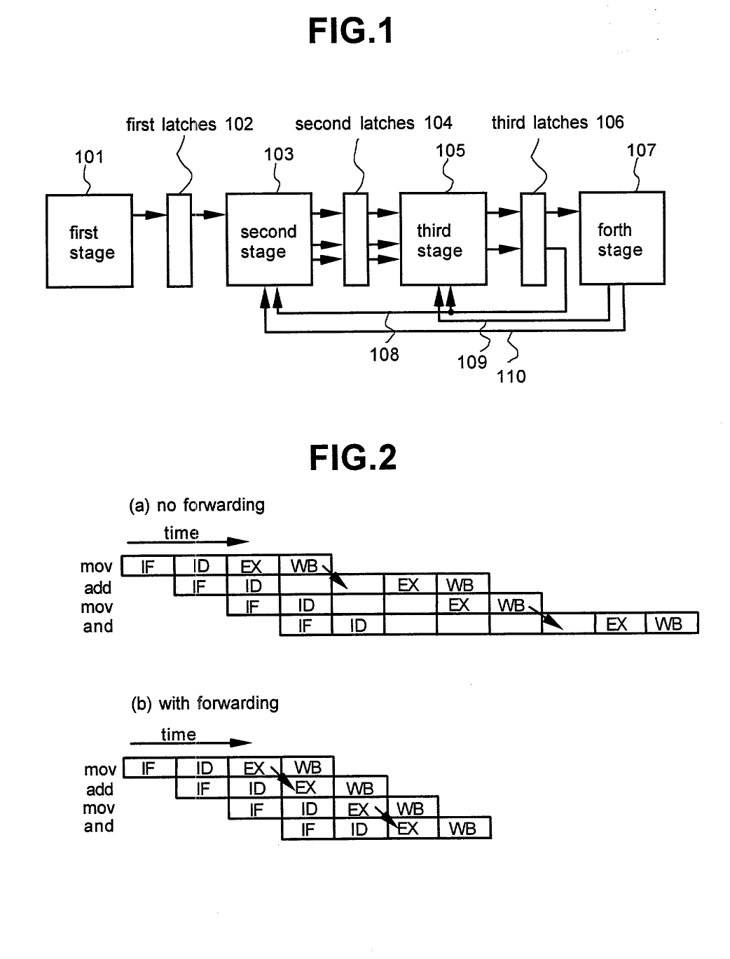

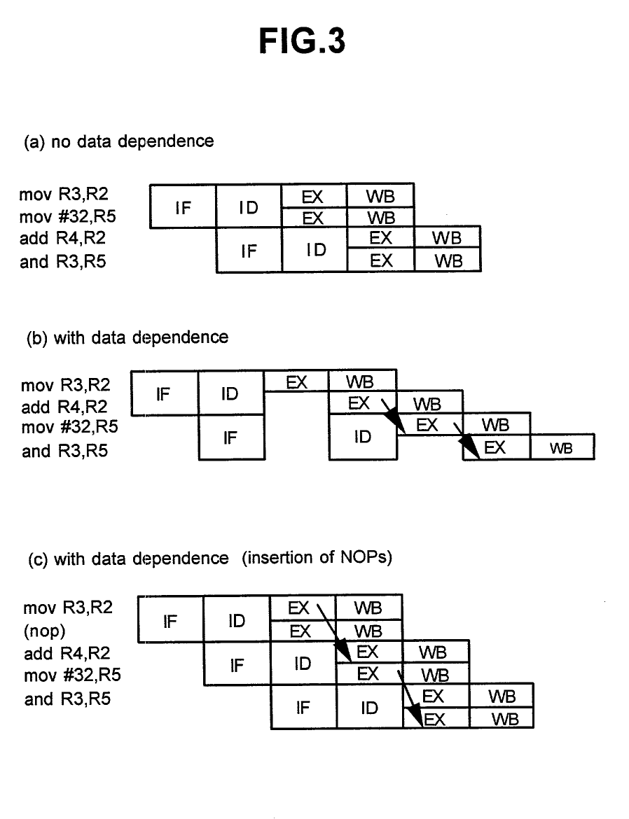

### DESCRIPTION OF THE PREFERRED EMBODIMENTS

A microprocessor according to an embodiment of the present invention will now be described in order by items.

<Pipeline Data Paths of a Microprocessor>

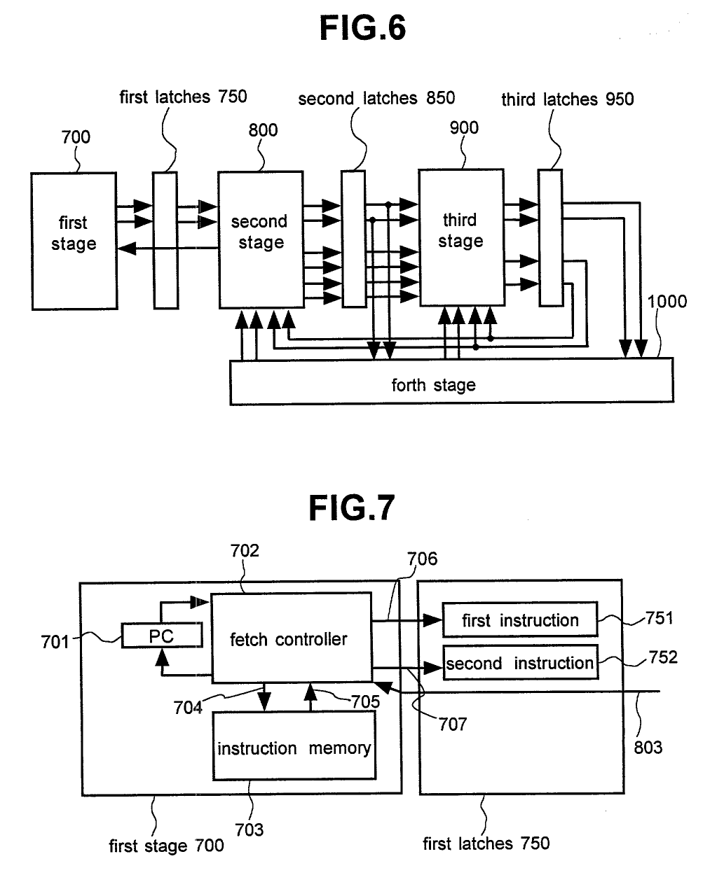

FIG. 6 illustrates data paths of pipelines in a microprocessor according to an embodiment of the present invention. The microprocessor described hereinbelow fetches and executes instructions of the 2-byte/2-operand instruction architecture as shown in FIG. 5.

A first stage 700 is an instruction fetch stage. A second stage 800 is an instruction decoder stage. A third stage 900 is an operation stage. A fourth stage 1000 writes data into a register and effects the forwarding. A first latch group 750, a second latch group 850 and a third latch group 950 exist among the above-mentioned stages. The stages in the embodiments of FIG. 6 and subsequent drawings are to illustrate the flow of data but are not to show physical arrangements of the circuits in the stages.

<Instruction Fetch Stage>

FIG. 7 is a block diagram illustrating the first stage 700 and the first latch group 750 in detail. The first stage 700 is constituted by a program counter (PC) 701, a fetch control unit 702, and an instruction memory 703. The role of the instruction fetch stage in the first stage 700 is to hand the instruction in the instruction memory over to the instruction decode stage in the second stage 800.

An address designated by a program counter 701 is sent onto a signal line 704, and 4 bytes of instructions (two instructions) in the instruction memory 703 are fetched by the fetch control unit 702 through a signal line 705. The two instructions fetched by the fetch control unit 702 are sent onto signal lines 706 and 707 according to a signal line 803. Then, a content of the signal line 706 is stored in a latch 751 in the first latch group 750, and a content of the signal line 707 is stored in a latch 752. The latch 751 stores a first instruction and the latch 752 stores a second instruction. In the string of instructions, the first instruction precedes the second instruction. In this application, the first instruction is also referred to as a preceding instruction and the second instruction is referred to as a succeeding instruction.

A value obtained by adding 4 to the value of the program counter 701 is set again to the program counter 701. The first stage 700 operates in a manner that four bytes of instructions (2 instructions) are fetched from the instruction memory under a limited condition where a value (value of address accessing the instruction memory) of the program counter 701 is a multiple of 2, and are latched into the first latch group 750. This, however, is not to mean that four bytes of instructions fetched from the instruction memory are directly latched to the first latch group 750 at all times. That is, the data related to how many bytes the instruction that is desired next is from the present instruction as viewed from the instruction decoder stage which is the second stage 800, is sent to the fetch control unit 702 in the first stage 700 via the signal line 803. In response thereto, the fetch control unit 702 in the first stage 700 utilizes a buffer in the fetch control unit 702, sends desired 4 bytes (2 instructions) of the instruction decoder stage onto the signal lines 706 and 707, and stores them in the latches 751, 752 in the first latch group 750.

<Instruction Decoder Stage>

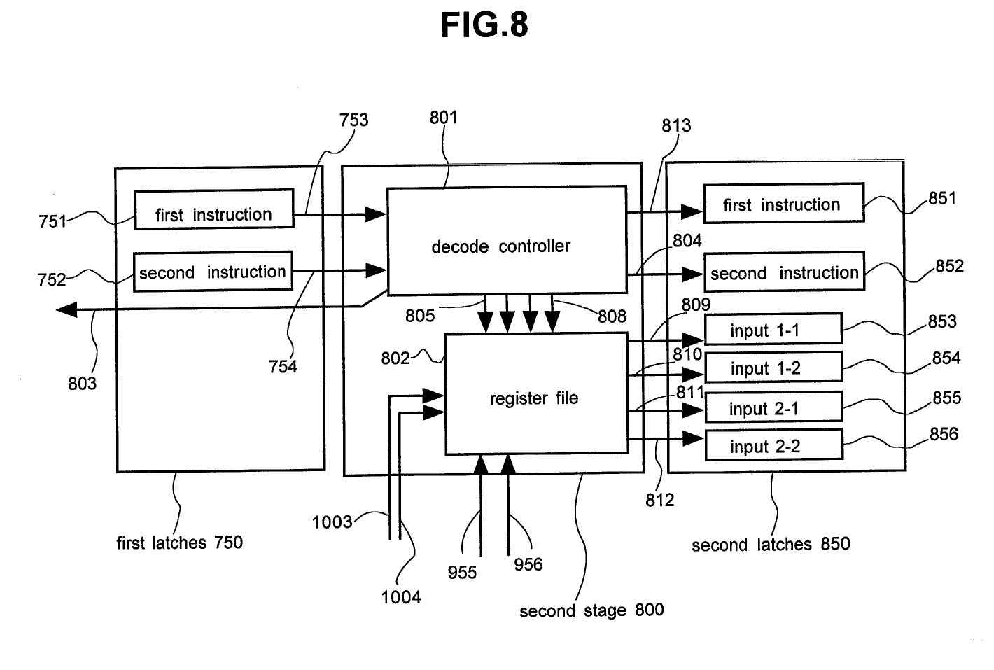

FIG. 8 is a block diagram illustrating a second stage 800 and a second latch group 850 in detail. The second stage 800 is constituted by a decoder control unit 801 and a register file 802. The roles of the instruction decoder stage in the second stage 800 are as described below.

(1) An input data used for the two instructions is prepared and is handed over to the next operation stage (third stage 900).

(2) The data flow between the two instructions is checked. When the result of execution of the preceding instruction (first instruction) is not used by the succeeding instruction (second instruction), the operation stage is asked to execute the processing for the two instructions.

(3) The data flow between the two instructions is checked. When the result of execution of the preceding instruction is used by the succeeding instruction, the two instructions are changed according to predetermined rules.

(4) The number of instructions which the operation stage is asked to execute is informed to the instruction fetch stage, to be ready for the next pipeline processing.

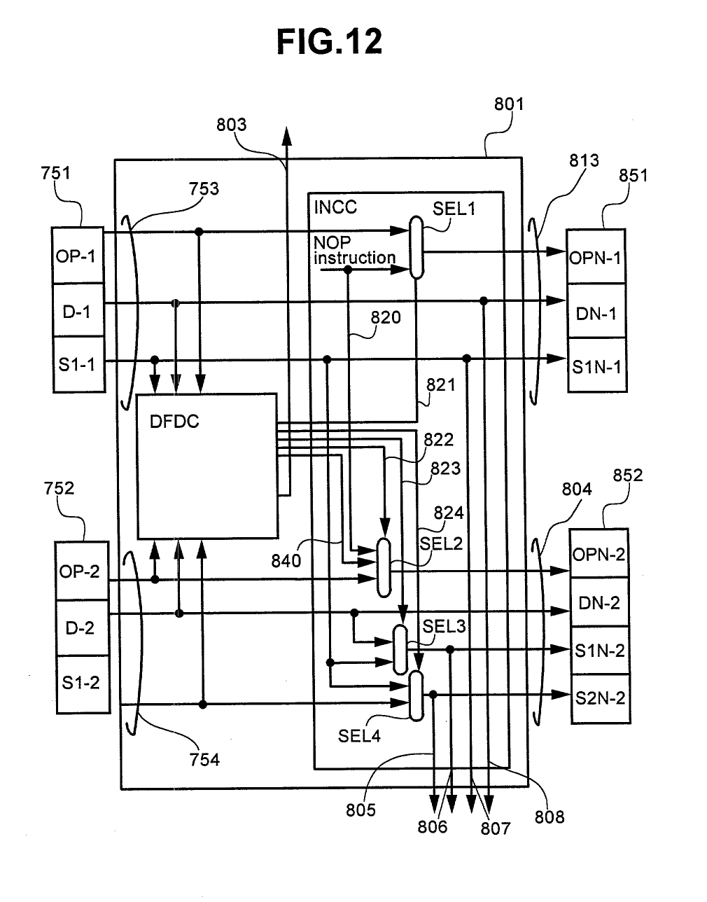

Described below is the operation of the instruction decoder stage (second stage 800). FIG. 12 is a block diagram illustrating part of the decoder control unit 801 in detail. The decoder control unit 801 has a data flow detector circuit DFDC, an instruction conversion circuit INCC and the like circuit. The instruction conversion circuit INCC has selectors SEL1 to 4, and processes the contents of the latches 751, 752 being controlled by the data flow detector circuit DFDC and converts them into the contents of the latches 851 and 852.

An OP-field of the first instruction which is the content of the latch 751 is denoted by OP-1, a D-field is denoted by D-1, and an S1-field is denoted by S1-1. An OP-field of the second instruction which is the content of the latch 752 is denoted by OP-2, a D-field is denoted by D-2, and an S1-field is denoted by S1-1. An OP-field of the first instruction which is the content of the latch 851 is denoted as OPN-1, a D-field is denoted as DN-1, and an S1-field is denoted as S1N-1. Ana OP-field of the second instruction which is the content of the latch 852 is denoted as OPN-2, a D-field is denoted as DN-2, and an S1-field is denoted as S1N-2. The second instruction which is the content of the latch 852 further has an S2-field which is denoted as S2N-2.

The decoder control unit 801 takes in the two instructions, i.e., the preceding instruction and the succeeding instruction from the latches 751 and 752 in the latch group 750 through the signal lines 753 and 754. Whether the register number of the D-field (D-1) of the preceding instruction is equal to the register number of the S1-field (S1-2) or the D-field (D-2) of the succeeding instruction or not is checked by the data flow detector circuit DFDC.

When the register numbers are not equal to each other, it is determined that there exists no data flow. When the register numbers are equal to each other, it is determined that there exists a data flow. Then, the data flow detector circuit DFDC outputs control signals 821 to 824, changes over the selectors SEL1 to 4, and stores the converted first instruction and second instruction in the latches 851 and 852 via signal lines 813, 804. A non-operation instruction NOP820 formed by INCC is input at all times to the inputs on one side of the selectors SEL1, SEL2.

The selector SEL2 receives a new instruction formed by the data flow detector circuit DFDC through a signal line 840. The new instruction input to the selector SEL2 through the signal line 840 is the one formed by the data flow detector circuit DFDC based upon OP-1 of latch 751 and OP-2 of latch 752, and is stored in OP-2 of latch 852. An example of a new instruction -that is formed may be a 1-bit shift addition instruction aslladd that is formed when OP-1 is a 1-bit shift instruction asll and OP-2 is an addition instruction add.

The selector SEL3 selects a value of either S1-1 or D-2 and stores it in S1N-2.

The selector SEL4 selects a value of either S1-1 or S1-2 and stores it in-S2N-2.

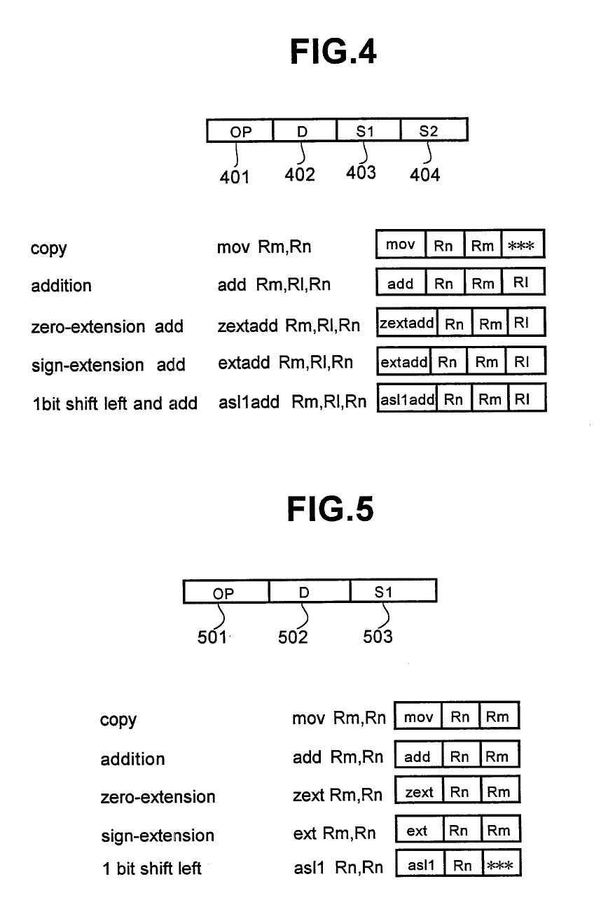

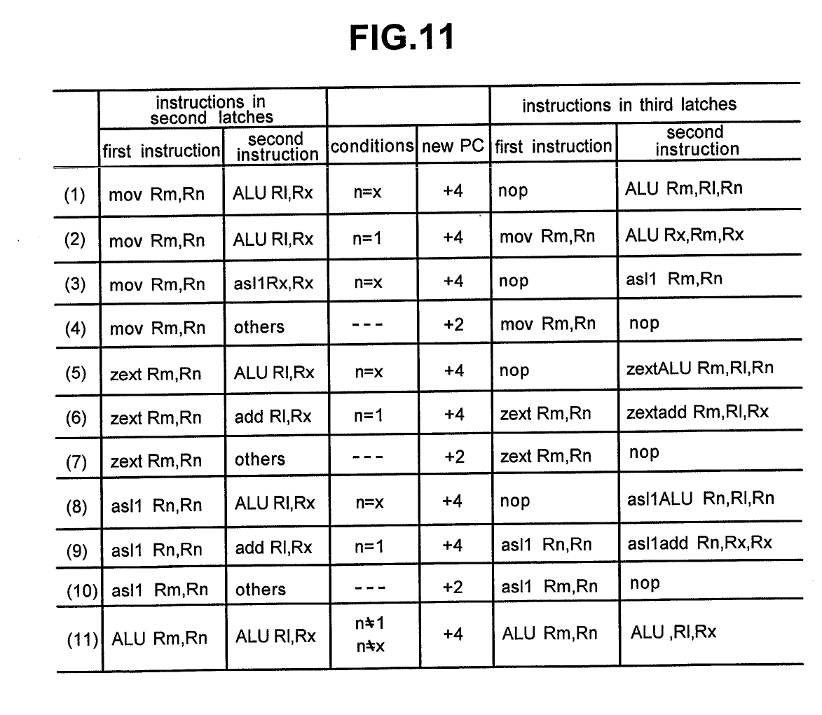

FIG. 11 illustrates rules (instructions covering the conditions and the operation stage) for converting two instructions of the instruction decoder stage into two instructions of the operation stage. The first instruction is either converted into a non-operation instruction nop or is not converted. The second instruction is converted in its instruction format from the 2-byte/2-operand format of FIG. 5 into the 4-byte/3-operand format of FIG. 4, or is converted into a non-operation instruction nop. In FIG. 11, ALU is an instruction name which is a general term for 2-input operation instructions such as arithmetic operations (addition, subtraction, etc.) and logic operations (AND, OR, etc.). As mentioned earlier, zextALU is an instruction for 0-extending a first input to the arithmetic unit and for effecting the ALU operation. asllALU is an instruction for shifting the first input to the arithmetic unit by one bit leftwardly and for effecting the ALU instruction.

FIG. 11(1) converts an operation instruction of the 2-operand format which requires two instructions of a copy instruction mov and an operation instruction ALU for executing an operation instruction of 3 operands, into an operation instruction ALU of 3 operands. This is a case where a register number of a D-field of the copy instruction mov is in agreement with the register number of a D-field of the operation instruction ALU. In this case, the first instruction is converted into a non-operation instruction nop and is handed over to the operation stage, and the second instruction is converted into a 3-operand operation instruction and is handed over to the operation stage.

Values stored in the fields of the latches 851 and 852 are summarized below. Here, “←” means that a value on the right side of “←” is stored on the left side of “←”.

| IF (D - 1) = (D - 2) | |
|---|---|
| THEN | OPN - 1 ← nop, |
| | OPN - 2 ← OP - 2, |
| | DN - 2 ← D - 2, |
| | S1N - 2 ← S1 - 1, |
| | S2N - 2 ← S1 - 2 |

Concrete examples are as described below. It is now assumed that “mov” is stored in OP-1 of the latch 751, “RN” is stored in D-1, and “Rm” is stored in S1-1. It is further assumed that “ALU” is stored in OP-2 of the latch 752, “RN” is stored in D-2 and “R1” is stored in S1-2. Here, the data flow detector circuit DFDC detects D-1 and D-2 which are both “RN” and having the same register number. Then, the data flow detector circuit DFDC so controls the selector SEL1 via 821 as to select the nop instruction 820, and stores the nop instruction 820 in OPN-1 of the latch 851. The data flow detector circuit DFDC directly stores D-1 and S1-1 of the latch 751 in DN-1 and S1-1 of the latch 851 via signal lines 753 and 813.

The data flow detector circuit DFDC so controls the selector SEL2 through the control signal 822 as to select OP-2 of the latch 752, and stores OP-2 of the latch 752 in OPN-2 of the latch 852. The data flow detector circuit DFDC further so controls the selector SEL3 through the control signal 823 as to select S1-1 of the latch 751, and stores S1-1 of the latch 751 in S1N-2 of the latch 852. Moreover, the data flow detector circuit DFDC stores D-2 of the latch 752 in DN-2 of the latch 852 via the signal line 754. The data flow detector circuit DFDC further so controls the selector SEL4 through 834 as to select S1-1 of the latch 752, and stores S1-1 of the latch 752 in S2N-2.

FIG. 11(2) is a case where a register number of a D-field of a copy instruction mov is in agreement with a register number of an S1-field of an operation instruction ALU. In this case, the first instruction is directly handed over to the operation stage, and the second instruction is converted into a 3-operand operation instruction and is handed over to the operation stage.

Values stored in the fields of the latches 851 and 852 are summarized below.

| IF (D - 1) = (S1 - 2), | |
|---|---|
| THEN | OPN - 1 ← OP - 1, |
| | DN - 1 ← D - 1, |
| | S1N - 1 ← S1 - 1, |
| | OPN - 2 ← OP - 2, |
| | DN - 2 ← D - 2, |
| | S1N - 2 ← S1 - 1, |
| | S2N - 2 ← D - 2 |

Concrete examples are as described below. It is now assumed that “mov” is stored in OP-1 of the latch 751, “RN” is stored in D-1, and “Rm” is stored in S1-1. It is further assumed that “ALU” is stored in OP-2 of the latch 752, “Rx” is stored in D-2 and “RN” is stored in S1-2. Here, the data flow detector circuit DFDC detects D-1 and S1-2 which are both “RN” and having the same register number. Then, the data flow detector circuit DFDC so controls the selector SEL1 via 821 as to select OP-1 (mov instruction in this case), and stores the mov instruction in OPN-1 of the latch 851.

The data flow detector circuit DFDC stores D-1 and S1-1 of the latch 751 in DN-1 and S1-1 of the latch 851 via signal lines 753 and 813. The data flow detector circuit DFDC so controls the selector SEL2 through the control signal 822 as to select OP-2 of the latch 752, and stores OP-2 of the latch 752 in OPN-2 of the latch 852. The data flow detector circuit DFDC stores D-2 of the latch 752 in DN-2 of the latch 852 via signal lines 754 and 804. The data flow detector circuit DFDC further so controls the selector SEL3 through the control signal 823 as to select S1-1 of the latch 751, and stores S1-1 of the latch 751 in S1N-2 of the latch 852 via the control signal 823. The data flow detector circuit DFDC stores S1-2 of the latch 752 in S2N-2 of the latch 852 via the signal lines 754 and 804.

The above-mentioned operation for forming values that are concretely stored in the latches 851 and 852 is not repeated after FIG. 11(2). The values to be stored in the latches 851 and 852 can be formed by the same method as the one of FIGS. 11(1) and 11(2).

FIG. 11(3) converts a 1-bit left shift instruction of the 1-operand format into a 1-bit left shift instruction of the 2-operand format. This is a case where a register number of a D-field of the copy instruction inov is in agreement with a register number of a D-field of the 1-bit left shift instruction asll. In this case, the first instruction is converted into a non-operation instruction nop and is handed over to the operation stage, and the second instruction is converted into a 1-bit left shift instruction asll of 2 operands and is handed over to the operation stage.

That is, the fields are converted as follows:

| IF (D - 1) = (S1 - 2), | |
|---|---|
| THEN | OPN - 1 ← nop, |
| | OPN - 2 ← OP - 2, |
| | DN - 2 ← D - 2 or D - 1, |
| | S1N - 2 ← S1 - 1, |
| | S2N - 2 ← NA |

FIG. 11(4) is a case where the first instruction is a copy instruction mov, and the second instruction or the condition corresponds to none of FIGS. 11(1), 11(2) and 11(3). In this case, the first instruction is directly handed over to the operation stage, and the second instruction is converted into a non-operation instruction nop and is handed over to the operation stage. Other instructions are executed by the next pipeline deviated by 1 clock. That is, the fields are converted as follows:

OPN-1←OP-1,

DN-1←D-1,

S1N-1←S1-1,

OPN-←nop

FIG. 11(5) combines a 0-extended instruction zext and an operation instruction ALU with a 0-extended operation instruction zextALU. This is a case where a register number of a D-field of the 0-extended instruction zext is in agreement with a register number of a D-field of the operation instruction ALU. In this case,, the first instruction is converted into a non-operation instruction nop and is handed over to the operation stage, and the second instruction is converted into a 0-extended operation instruction zextALU of 3 operands and is handed over to the operation stage.

The fields are converted as follows:

| IF (D-1) = (D - 2), | |
|---|---|
| THEN | OPN - 1 ← nop, |
| | OPN - 2 ← zexALU, |
| | DN - 2 ← D - 2 or D - 1, |
| | S1N - 2 ← S1 - 1, |
| | S2N - 2 ← S1 - 2 |

FIG. 11(6) is a case where a register number of a D-field of a 0-extended instruction zext is in agreement with a register number of an S1-field of an addition instruction add. In this case, the first instruction is directly handed over to the operation stage, and the second instruction is converted into a 0-extended addition instruction zextadd of 3 operands and is handed over to the operation stage.

The fields are converted as follows:

| IF (D - 1) = (S1 - 2), | |
|---|---|
| THEN | OPN - 1 ← OP - 1, |
| | DN - 1 ← D - 1, |
| | S1N - 1 ← S1 - 1, |
| | OPN - 2 ← zextadd, |
| | DN - 2 ← D - 2, |
| | S1N - 2 ← S1 - 1, |
| | S2N - 2 ← D - 2 |

In addition to addition instructions add, AND instructions “and” and OR instructions “or” may be subjected to similar conversions.

FIG. 11(7) is a case where the first instruction is a 0-extencded instruction zext, and the second instruction or the condition corresponds to neither FIG. 11(5) nor 11(6). In this case, the first instruction is directly handed over to the operation stage, and the second instruction is converted into a non-operation instruction nop and is handed over to the operation stage. Other instructions are executed by the next pipeline deviated by one clock.

The fields are converted as follows:

OPN-1←OP-1,

DN-1←D-1,

S1N-1←S1-1,

OPN-2←nop

FIG. 11(8) combines a 1-bit left shift instruction asll and an operation instruction ALU with a 1-bit left shift operation instruction asllALU. This is a case where a register number of a D-field of the 1-bit left shift instruction asll is in agreement with a register number of a D-field of the operation instruction ALU. In this case, a first instruction is converted into a non-operation instruction nop and is handed over to the operation stage, and the second instruction is converted into a 1-bit left shift operation instruction asllALU of 3 operands and is handed over to the operation stage.

The fields are converted as follows:

| IF (D - 1) = (D - 2), | |
|---|---|
| THEN | OPN - 1 ← nop, |
| | OPN - 2 ← asllALU, |
| | DN - 2 ← D - 2, |
| | S1N - 2 ← S1 - 1, |
| | S2N - 2 ← S1 - 2 |

FIG. 11(9) is a case where a register number of a D-field of a 1-bit left shift instruction asll is in agreement with a register number of an S1-field of an addition instruction add. In this case, the first instruction -is directly handed over to the operation stage, and the second instruction is converted into a 1-bit left shift addition instruction aslladd of 3 operands and is handed over to the operation stage.

The fields are converted as follows:

| IF (D - 1) = (S1 - 2), | |
|---|---|
| THEN | OPN - 1 ← OP - 1, |
| | DN - 1 ← D - 1, |
| | S1N - 1 ← S1 - 1, |
| | OPN - 2 ← aslladd, |
| | DN - 2 ← D - 2, |
| | S1N - ← S1 - 1, |
| | S2N - 2 ← D - 2 |

FIG. 11(10) is a case where the first instruction is a 1-bit left shift instruction asll, and the second instruction or the condition corresponds to neither FIG. 11(8) nor 11(9). In this case, the first instruction is directly handed over to the operation stage, and the second instruction is converted into a non-operation instruction nop and is handed over to the operation stage. Other instructions are executed by the next pipeline deviated by one clock.

The fields are converted as follows:

OPN-1←OP-1,

DN-1←D-1,

S1N-1←S1←1

OPN-2←nop

FIG. 11(11) is a case where there is no data flow between the two instructions, and the instructions are not converted.

The two new instructions converted by the decoder control unit 801 are sent onto the signal lines 813 and 804 and are stored in the latches 851 and 852 in the second latch group 850. Furthermore, the result of checking a relationship between the preceding instruction and the succeeding instruction in the data flow detector circuit DFDC is informed to the instruction fetch stage (first stage 700) based on a PC updated value of FIG. 11 via the signal line 803. That is, the instruction fetch stage is informed of a data for designating two instructions that are to be decoded in a next pipeline.

The decoder control unit 801 sends four register numbers of S1-field (S1-1) and D-field (D-1) of the preceding instruction and of S1-field 503 (S1-2) and D-field 502 (D-2) of the succeeding instruction to a register file 802 via signal lines 805, 806, 807 and 808. The contents of the four registers in the register file 802 are read onto signal lines 809, 810, 811 and 812, and are stored in a latch 853 (1-1 input), latch 854 (1-2 input), latch 855 (2-1 input) and latch 856 (2-2 input) in the second latch group 74.

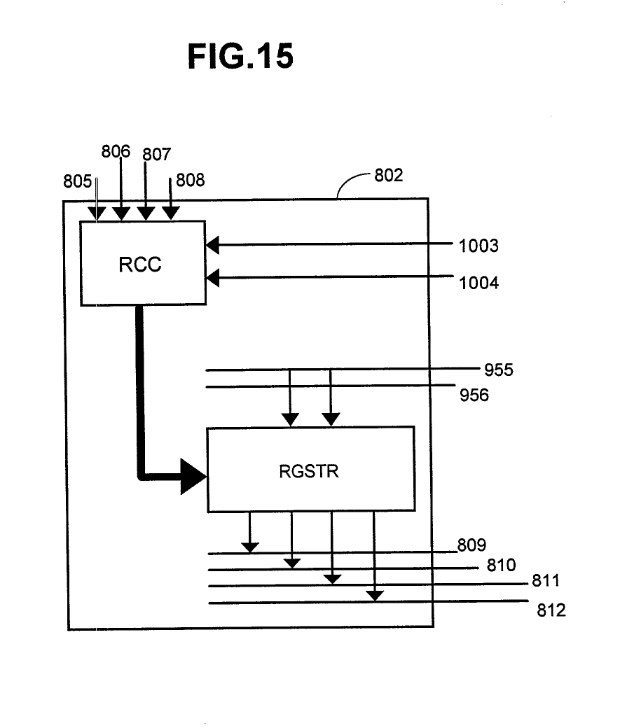

FIG. 15 is a block diagram of the register file 802 which is constituted by a register RGSTR, a register control circuit RCC, etc. The register RGSTR has four read ports and two write ports which are connected to signal lines 809, 810, 811, 812 and signal lines 955, 956. Therefore, the register file 802 is capable of simultaneously reading the contents of the four registers. Besides, the data can be written into two registers, simultaneously.

In the cases of FIGS. 11(1), 11(5) and 11(8), the contents of the two registers designated by (S1-1) and (S1-2) are read onto the signal lines 811 and 812, and are stored in the latch 855 (2-1 input) and the latch 856 (2-2 input).

In the cases of FIGS. 11(2), 11(6) and 11(9), the content of the register designated by (S1-1) is read onto the signal lines 809 and 811, and is stored in the latch 853 (1-1 input) and the latch 855 (2-1 input). The content of the register designated by (D-2) is read onto the signal line 812, and is stored in the latch 855 (2-2 input).

In the case of FIG. 11(3), the content of the register designated by (S1-1) is read onto the signal line 811 and is stored in the latch 855 (2-1 input).

In the cases of FIGS. 11(4), 11(7) and 11(10), the content of the register designated by (S1-1) is read onto the signal line 809 and is stored in the latch 853 (1-1 input).

In the case of FIG. 11(11), the contents of the four registers designated by (S1-1), (D-1), (S1-2) and (D-2) are read onto the signal lines 809, 810, 811 and 812, and are stored in the latch 853 (1-1 input), latch 854 (1-2 input), latch 855 (2-1 input) and latch 856 (2-2 input).

<Execution Stage>

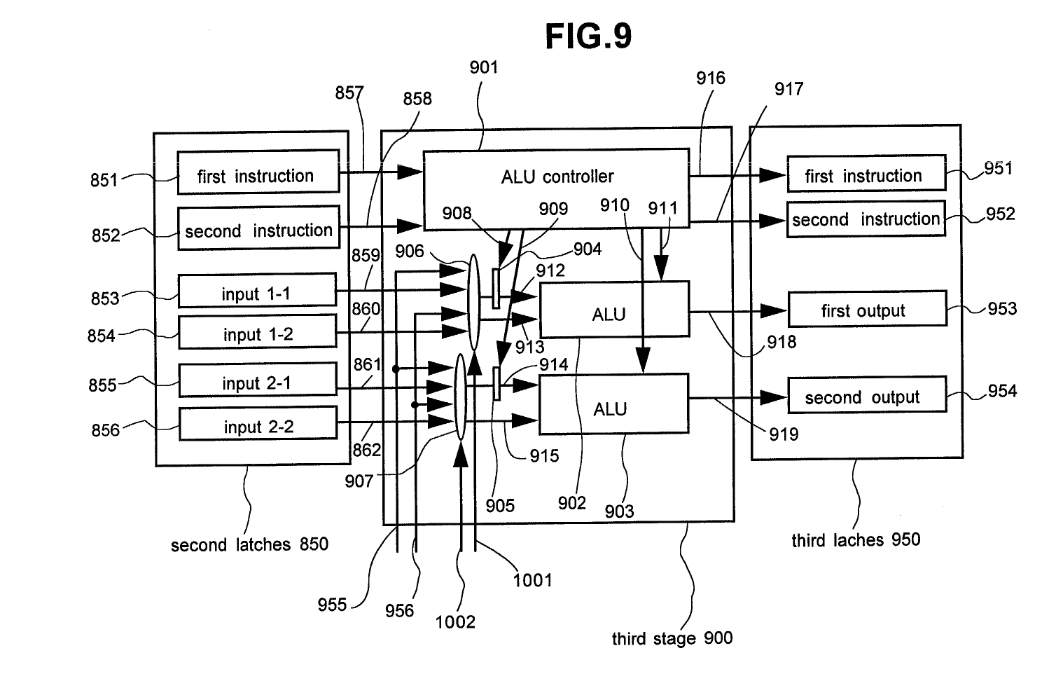

FIG. 9 is a block diagram illustrating the third stage 900 and the third latch group 950 in detail. The third stage 900 is constituted by an operation control unit 901, arithmetic units 902 and 903 including ALU (arithmetic logic unit, etc.), first input adjusting circuits 904 and 905, and selectors 906 and 907. The role of the execution stage which is the third stage 900 is to execute the operation of two instructions.

The arithmetic unit 902 and the first input adjusting circuit 904 operate the preceding instruction. The 1-1 input and the 1-2 input are sent from the two latches 853 and 854 in the second latch group 850 to the selector 906 via the signal lines 859 and 860. Furthermore, the first output and the second output are sent from the two latches 953 and 954 in the third latch group 950 to the selector 906 via the signal lines 955 and 956.

The selector 906 selects one of the signal lines 859, 955 and 956 according to a signal line 1001, and sends the data to the arithmetic unit 902 via the first input circuit 904 and the signal line 912. The selector 906 further selects one of the signal lines 860, 955 and 956 according to the signal line 1001, and sends the data to the arithmetic unit 902 via the signal line 913.

The arithmetic control unit 901 takes in an instruction from the latch 851 in the second latch group 850, controls the arithmetic unit 902 and the first input adjusting circuit 904 according to the instruction function through the signal lines 911 and 908, and executes the arithmetic operation for the preceding instruction. A value (first output) of the result is stored in the latch 953 in the third latch group 950 through the signal line 918.

On the other hand, the arithmetic unit 903 and the first input adjusting circuit 905 work to operate the succeeding instruction, and the 2-1 input and the 2-2 input are sent from the two latches 855 and 856 in the second latch group 850 to the selector 907 via the signal lines 861 and 862. Furthermore, the first output and the second output are sent from the two latches 953 and 954 in the third latch group 950 to the selector 907 via the signal lines 955 and 956.

The selector 907 selects one of the signal lines 861, 955 and 956 according to a signal line 1002, and sends the data to the arithmetic unit 903 via the first input circuit 905 and the signal line 914. The selector 907 further selects one of the signal lines 862, 955 and 956 according to the signal line 1002, and sends the data to the arithmetic unit 903 via the signal line 915. The arithmetic control unit 901 takes in an instruction from the latch 852 in the second latch group 850, controls the arithmetic unit 903 and the first input adjusting circuit 905 according to the instruction function through the signal lines 910 and 909, and executes the arithmetic operation for the succeeding instruction. A value (second output) of the result is stored in the latch 954 in the third latch group 950 through the signal line 919.

In the foregoing were mentioned the processings in the execution stage (third stage 900). Here, the description will be added concerning the sladd instruction and zextadd instruction. The aslladd instruction and the zextadd instruction can be realized by finely adjusting the first input to the arithmetic unit 902 or 903 which is capable of realizing the addition. That is, the first input is not directly input to the arithmetic unit but is input to the first input adjusting circuit 904 or 905 which is controlled by the operation control unit 901 to execute 1-bit left shift or 0-extension, and is, then, input to the arithmetic unit 902 or 903 where the addition is executed in an ordinary manner.

<Write Stage>

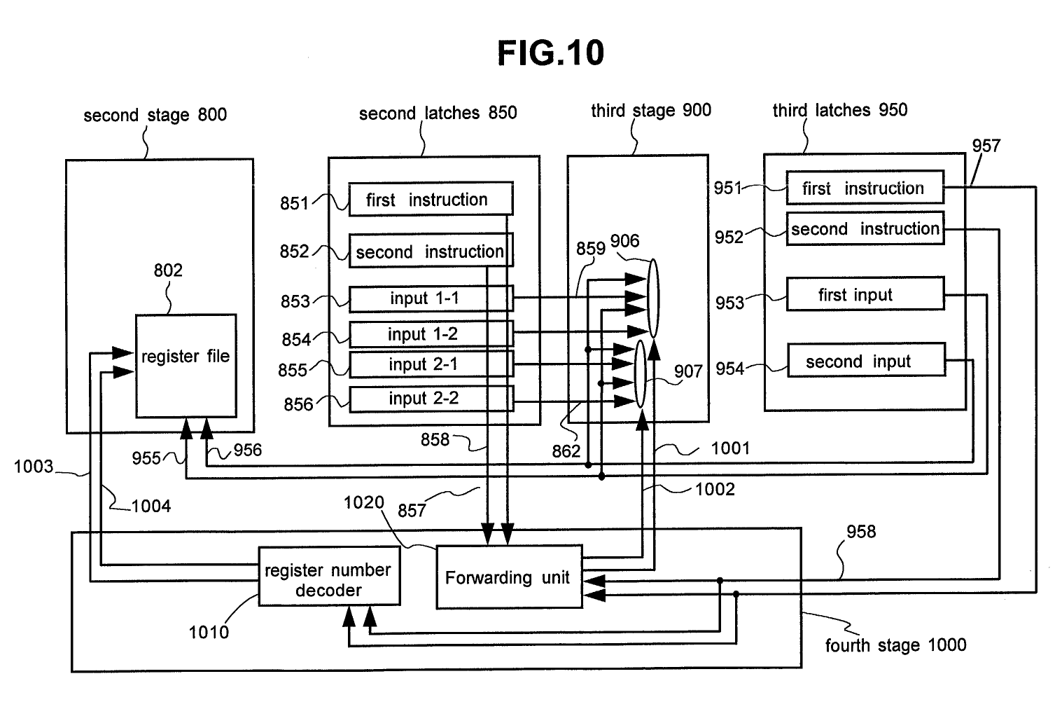

FIG. 10 is a block diagram for explaining the operation of a fourth stage 1000. The fourth stage 1000 is constituted by a register number decoder circuit 1010 and a forwarding control circuit 1020. The roles of the fourth stage 1000 for writing data into the register and for executing the forwarding are as described below.

(1) The result of operation of the two instructions is written into a register of a designated number.

(2) When the result of operation of the two instructions is used in the operation stage (next pipeline) in the present clock, the fourth stage so works that not the value latched in the second latch group 850 but the value latched in the third latch group 950 is input to the arithmetic unit (forwarding).

Described below first is the processing (1). The fourth stage 1000 takes the two instructions operated immediately before from the latches 951 and 952 in the third latch group 950 into the register number decoder circuit 1010 via the signal lines 957, 958. Moreover, a value of the result of the preceding operation is sent onto the signal lines 955 and 956 from the latches 953, 954 in the third latch group 950. The register number decoder circuit 1010 sends register numbers in two D-fields of instructions executed immediately before onto the signal lines 1003 and 1004, and designates a write register number of a register file 802 in the second stage 800. Thus, the values of the results of two operations are written into the register file 802.

Next, described below is the processing (2). The fourth stage 1000 takes two instructions that are to be operated this time from the latches 851 and 852 in the second latch group 850 into the forwarding control circuit 1020 via the signal lines 857 and 858. Furthermore, the two instructions operated immediately before are taken into the forwarding control circuit 1020 via the signal lines 957 and 958 from the latches 951 and 952 in the third latch group 950. The forwarding control circuit 1020 checks whether the register numbers in the two D-fields of the instructions executed immediately before and the numbers of SI-field and S2-field of the two instructions operated this time are the same or not. When there are the same numbers as a result of checking, the forwarding control circuit 1020 so controls the two selectors 906 and 907 through the signal lines 1001 and 1002 that the values (signal lines 955, 956) of the latches 953, 954 in the third latch group 950 are input to the arithmetic units 902 and 903 instead of the values of the latches 853, 854, 855 and 856 in the second latch group 850.

<Processing of a String of Instructions>

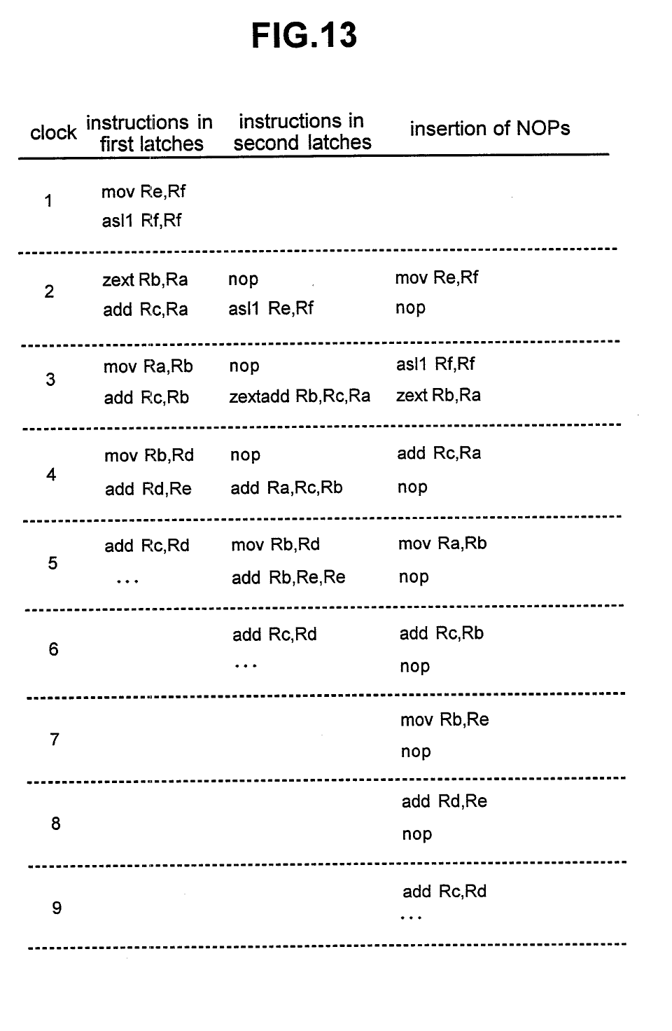

FIG. 13 illustrates how a string of instructions are processed in the individual clocks in the superscalar processing of the present invention. For the purpose of comparison, furthermore, FIG. 13 illustrates how the string of instructions are processed in the individual clocks by simply inserting a non-operation instruction nop in the case when the two instructions cannot be executed in parallel. According to the present invention, two instructions can be processed in a single clock. According to the present invention, furthermore, the number of instructions to be executed is decreased by 6 and the execution time is shortened (in this string of instructions, the instructions to be executed is decreased by about 40%) compared with when the non-operation instruction nop is inserted under the condition where the two instructions cannot be executed in parallel.

When the preceding instruction is a transfer instruction such as mov, zext, asll, etc. and the succeeding instruction is an addition instruction such as add, the two instructions are converted into a single instruction and is executed in one clock. Therefore, the number of clocks as a whole can be decreased to increase the operation speed. Even when the preceding instruction is a transfer instruction, the succeeding instruction is an operation instruction, and a data flow exists between them, it is allowed to execute the two instructions in one clock, making it possible to decrease the number of clocks as a whole and to increase the speed of operation.

<Application to a Microcomputer>

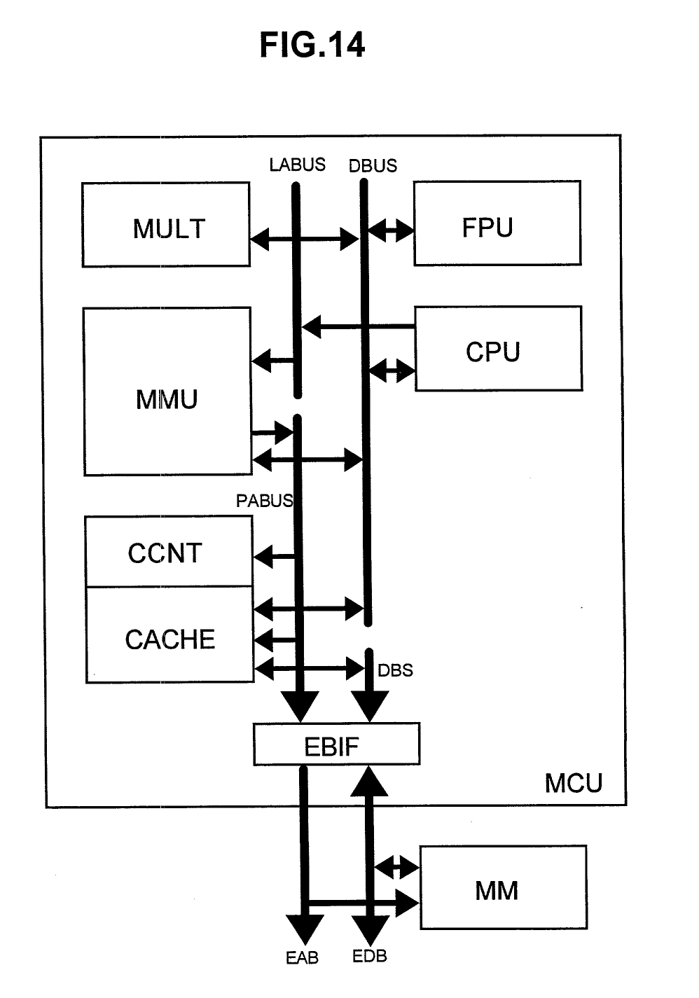

FIG. 14 illustrates a microcomputer system employing the superscalar system of the present invention. The microcomputer MCU comprises a central processing unit CPU, a floating-point processing unit FPU, a multiplier MULT having a sum-of-product operation function, a memory managing unit MMU for converting a logical address into a physical address, an instruction and data cache memory CACHE, a cache controller CCNT, an external bus interface EBIF, a 32-bit logic address bus LABUS, a 32-bit physical address data bus PABUS, and 32-bit data buses DBUS and DBS which are formed on a semiconductor substrate such as single crystalline silicon which is molded with a resin (sealed in a plastic package).

The microcomputer MCU is connected, via an external address bus EAB and a data bus EDB, to a main memory MM which comprises a semiconductor memory using dynamic memory elements such as DRAM's as memory cells.

The central processing unit CPU is constituted by pipeline data paths shown in FIG. 6. Here, however, a memory access stage is provided between the third stage and the fourth stage to constitute a so-called 5-stage pipeline. The data memory and the instruction memory 703 correspond to the cache memory CACHE or the main memory MM, but do not exist in the central processing unit CPU. The central processing unit CPU executes instructions of an instruction architecture of a fixed length of 2 bytes, and the arithmetic units 902 and 903 have an ALU of a length of 32 bits, respectively. Furthermore, the register file 802 has 16 general-purpose registers of a length of 32 bits. That is, the central processing unit CPU executes instructions of a 2-byte/2-operand instruction architecture (instruction set) disclosed in Japanese Unexamined Patent Publication (Kokai) No. 5-197546. The CPU disclosed in Japanese Unexamined Patent Publication (Kokai) No. 5-197546 is not the one of the superscalar system. On the other hand, the central processing unit CPU is of the superscalar system and is capable of executing the same instruction architecture as the one disclosed in Application No. 1992/897457. Therefore, the central processing unit CPU is capable of realizing a high-speed performance yet maintaining compatibility (object code compatibility) with the conventional softwares. It also maintains a high coding efficiency which is a feature of the 2-byte fixed-length instruction.

In the foregoing was concretely described the invention accomplished by the present inventors by way of embodiments. It should, however, be noted that the present invention is in no way limited thereto only but can be modified in a variety of ways without departing from the spirit and scope of the invention. For example, the embodiment of FIG. 6 and subsequent drawings has dealt with the case of the 2-byte/2-operand instruction architecture which, however, can also be applied to the case of the 4-byte/3-operand instruction architecture. The 0-extended instruction and the 0-extended operation instruction were explained, but the same can also be applied even to the code extended instruction and the code extended operation instruction. In the foregoing was further described the case where the S1-field of transfer instruction of the first instruction has designated the register, which, however, can also be adapted to the case of immediate data.

Briefly described below is the effect obtained by a representative example of the invention disclosed in this application.

A data flow between the neighboring instructions is detected, and the instructions are converted and are executed in parallel. Therefore, the processing of a plurality of instructions, which so far required a time of a plurality of clocks, can now be executed in one clock. Accordingly, the number of execution clocks as a whole can be decreased.

We claim:

1. A data processing apparatus for executing instructions by dividing them into a plurality of stages; wherein
said plurality of stages include a first stage for taking in instructions from at least an instruction memory, a second stage for decoding instructions taken in at said first stage, a third stage for executing instructions decoded at said second stage, and a fourth stage for writing the result executed at said third stage into a register; and wherein
instructions of a first instruction format stored in said instruction memory are converted into instructions of a second instruction format and are executed.

2. A data processing apparatus according to claim 1, wherein said first instruction format is the one which operates a first operand and a second operand in the operation instruction, and stores the result of operation in a second operand, and wherein said second instruction format is the one which operates a first operand and a second operand in the operation instruction, and stores the result of operation in a third operand.

3. A data processing apparatus according to claim 2, wherein said second stage detects that a preceding instruction is a data transfer instruction between the registers, that a succeeding instruction is an operation instruction, and that a register number at a destination to where the preceding instruction will be transferred is the same as the register number at a destination to where the succeeding instruction will be transferred, and converts the instructions into operation instructions of said second instruction format and sends them to said third stage.

4. A data processing apparatus according to claim 3, wherein said data processing apparatus is formed on a single semiconductor substrate.

5. A data processing apparatus according to claim 4, wherein said preceding instruction is a data transfer instruction for transferring the content of a register at a source of transfer directly to a register at a destination of transfer.

6. A data processing apparatus according to claim 4, wherein said preceding instruction is a data transfer instruction which shifts the content of a register at a destination of transfer and transfers it to a register at the destination of transfer.

7. A data processing apparatus according to claim 4, wherein said preceding instruction is a data transfer instruction which 0-extends or code-extends the content of a register at a source of transfer and transfers it to a register at the source of transfer.

8. A data processing apparatus according to claim 1, wherein said second instruction format has an instruction formed by combining a plurality of instructions of said first instruction format.

9. A data processing apparatus according to claim 8, wherein said second stage detects that a preceding instruction is a data transfer instruction between the registers, that a succeeding instruction is a fixed-bit shift instruction and that a register number at a destination to where the preceding instruction will be transferred is the same as the register number at a source from where the succeeding instruction is transferred, and converts the instructions into a shift instruction of said second instruction format and sends them to said third stage.

10. A data processing apparatus according to claim 2, wherein said second stage detects that preceding instruction is a data transfer instruction between the registers, that a succeeding instruction is an operation instruction, and that a register number at a destination to where the preceding instruction will be transferred is the same as the register number at a source from where the succeeding instruction is transferred, converts the succeeding instruction into an operation instruction of said second instruction format which has no relation of data flow with respect to the preceding instruction, and sends it to said third stage, so that a plurality of the same stages can be executed in parallel.

11. A data processing apparatus according to claim 10, wherein said first instruction format is a 2-byte fixed-length instruction.

12. A data processing apparatus according to claim 11, wherein said preceding instruction is a data transfer instruction which transfers the content of a register at a source of transfer directly to a register at a destination of transfer.

13. A data processing apparatus according to claim 11, wherein said preceding instruction is a data transfer instruction which shifts the content of a register at a destination of transfer and transfers it to a register at the destination of transfer.

14. A data processing apparatus according to claim 11, wherein said preceding instruction is a data transfer instruction which 0-extends or code-extends the content of a register at a source of transfer and transfers it to a register at the source of transfer.

15. A data processing apparatus of the pipeline system comprising:
a first stage for reading instructions of a fixed length stored in an instruction memory;
a second stage which, when there is dependency on the data executed by a plurality of instructions that are read and when there is a predetermined relationship among said plurality of instructions, changes said plurality of instructions so as to be executed in parallel by a plurality of pipelines; and
a third stage for executing said plurality of changed instructions in parallel.

16. A data processing apparatus according to claim 15, wherein said first stage reads two instructions simultaneously, and said second stage changes said two instructions so as to be executed in parallel by two pipelines.

17. A data processing apparatus according to claim 16, wherein said first stage reads 2-byte fixed-length instructions.

18. A microcomputer forming a CPU and an instruction memory on a single semiconductor substrate, wherein said CPU comprises:
an instruction fetch unit for reading two 2-byte fixed-length instructions stored in an instruction memory;
an instruction decoder which, when there is dependency on the data executed by said two instructions that are read and when there is a predetermined relationship between said two instructions, changes said two instructions so as to be executed in parallel by two pipelines; and
two 4-byte-long arithmetic units for executing the changed two instructions in parallel.

19. A microcomputer according to claim 18, wherein said instruction decoder operates a first operand and a second operand in the operation instruction, and changes the instruction for storing the result of operation in the second operand into an instruction which operates the first operand and the second operand and stores the result of operation in the third operand.

20. A microcomputer according to claim 18, wherein said instruction decoder detects that a preceding instruction is a data transfer instruction between the registers, that a succeeding instruction is an operation instruction and that a register number at a destination to where the preceding instruction will be transferred is the same as the register number at a source from where the succeeding instruction is transferred, and changes the succeeding instruction into an operation instruction which has no relation of data flow with respect to the preceding instruction.
